(19) United States
(12) Patent Application Publication
(10) Pub. No.: US 2009/0015379 A1
(43) Pub. Date: Jan. 15, 2009

(54) APPARATUS AND METHOD FOR CONTEXT-BASED WIRELESS INFORMATION PROCESSING

(76) Inventor: Einar Rosenberg, Deerfield Beach, FL (US)

Correspondence Address: DICKSTEIN SHAPIRO LLP, 1825 EYE STREET NW, Washington, DC, 20006-5403, US

(21) Appl. No.: 12/180,222

(22) Filed: Jul. 25, 2008

Related U.S. Application Data
(63) Continuation-in-part of application No. 12/007,160, filed on Jan. 7, 2008.
Application No. 12/007,160 is a continuation-in-part of application No. 11/105,410, filed on Apr. 14, 2005, now Pat. No. 7,330,714.
Application No. 11/105,410 is a division of application No. 10/848,405, filed on May 19, 2004, now Pat. No. 7,110,792.
(60) Provisional application No. 60/952,355, filed on Jul. 27, 2007.
(60) Provisional application No. 61/071,900, filed on May 23, 2008.

(51) Int. Cl. H04Q 5/22; G06F 7/06; G06F 17/30; G06F 15/16

(52) U.S. Cl. 340/10.1; 707/4; 709/202; 707/E17.044

(57) ABSTRACT

A context of the user of a mobile communication device determines what product or service is requested. By determining where the mobile communication device is, unique identifying information is used to identify a specific product or service. By using information regarding products limited to a defined area, a reduced product/service identifier can be used on products/services.

### CROSS REFERENCE TO RELATED APPLICATIONS

The present application claims benefit to U.S. Patent Application Ser. No. 60/952,355, filed on Jul. 27, 2007 and U.S. Patent Application Ser. No. 61/071,900, filed on May 23, 2008, the disclosures of which are incorporated by reference in their entirety. The present application is a continuation in part of U.S. patent application Ser. No. 12/007,160, filed Oct. 1, 2007, which is continuation in part of U.S. patent application Ser. No. 11/105,410, filed Apr. 14, 2005, now issued as U.S. Pat. No. 7,330,714, which is a divisional application of U.S. patent application Ser. No. 10/848,405, filed May 19, 2004, now issued as U.S. Pat. No. 7,110,792.

### FIELD OF THE INVENTION

Embodiments of the invention relate generally to improved methods and an apparatus for wireless communications, and more specifically at using contextual information to assist in a communication process.

### BACKGROUND OF THE INVENTION

Cellular telephones are everywhere. As is well known, it is generally understood that most people do not go anywhere without their cellular telephone, or other personal communication device. Whether going to school, shopping, or the movies, consumers have their cellular telephone with them.

There always exists a desire for keeping things short and simple. It is believed that the easier that something is the better and/or more enjoyable it is, ideally by making it shorter and/or simpler. For example, when shopping many consumers prefer the simplicity of using credit and/or debit cards instead of cash. When traveling, some travelers prefer the ease of using a Speedpass™ to purchase gas or using an EasyPass™ to pay for tolls while passing through a toll plaza instead of stopping at a toll booth and performing a conventional toll fee transaction. In communications, theoretically, the shorter/quicker, the better, whether it is the size of the data or the distance to travel. Additionally, wireless communications are now significantly preferred over land lines by many users.

Identification medium, i.e., labels, such as UPC, RFID, and other types of physical/electronic labels, are used to provide information about the item that the label is attached to and to identify goods both for tracking physical shipments and for transactions. For example, in a food establishment, labels on foods, generally UPC labels, provide information about the product to which it is attached. This information is used by both a consumer and the establishment to uniquely identify the product. The labels are generally cross referenced in a database, or “look up tables,” to provide additional information about the product. With the typically large number of products in the general marketplace and the need to keep things simple, there is a desire to reduce information contained on the labels required to identify the product.

Furthermore, when using an electronic device, it would be desirable to have the device know the appropriate application that a user would want and automatically start that application. For example, when using a personal computer in a public library, it would be desirable for the computer to recognize its context and automatically start an application associated with the library, e.g., a card catalog system for the library.

### BRIEF DESCRIPTION OF THE DRAWINGS

FIG. 1a is a diagram showing a context-based product/service/information request system in accordance with an embodiment of the invention;

FIG. 2(a) is an overhead map illustrating zones of the context-based product/service/information request system;

FIG. 2(b) is table of color region locations to be used in the context-based product/service/information request system;

FIG. 2(c) shows a matrix bar code;

FIGS. 3(a) and 3(b) depict lookup tables of information to be used in the context-based product/service/information request system;

FIG. 4 is a diagram depicting context-based product/service/information request system in accordance with an another embodiment of the invention;

FIG. 5 is a diagram showing a detailed depiction of the context-based product/service/information request system of FIG. 4;

FIGS. 6(a)-(e) show the use of a mobile communication device to perform paging according to an exemplary embodiment;

FIG. 7 shows the use of a mobile communication device to receive information according to an exemplary embodiment;

FIG. 8 shows the use of a mobile communication device to be directed to an Internet location; and

FIGS. 9(a) and 9(b) show the use of a mobile communication device in virtually linking two electronic devices by bridging them virtually with a mobile communication device that reads identification information.

### DETAILED DESCRIPTION OF THE INVENTION

In the following detailed description, reference is made to the accompanying drawings, which form a part hereof, and in which is shown by way of illustration specific embodiments. These embodiments are described in sufficient detail to enable those of ordinary skill in the art to make and use them, and it is to be understood that structural, logical, or procedural changes may be made.

In an embodiment, a product's or service's reduced identifying information in a store is collected and a context of the product or service, e.g., the store, is collected and forwarded to a computer system. The computer system determines the product or service requested and contacts the store's computer system to order the product or service. Because the context of the request is determined to be a particular store, the number of available products or services available at that particular store is smaller than the number of products or services generally available in the marketplace. The smaller the number of available products the smaller number of product identification numbers required to uniquely identify them. Thus, a reduced product identification medium having reduced product identifying information can be used on products of a store, where the reduced product identifying information contains less information than a standard product identification medium having standard product identifying information.

For example, a user shops in a supermarket and takes a mobile communication device (“MCD”) into the supermarket with him. Although standard UPC identification mediums uniquely correspond to millions of products which therefore requires standard UPC identification mediums having millions of unique serial numbers, a supermarket carries a limited number of those products. Thus, a UPC identification medium with reduced information, e.g., less information than the standard UPC identification mediums commensurate with the context (e.g., the supermarket), can uniquely identify the products that supermarket carries. For example, if a supermarket only carries ten thousand products, then a UPC identification medium for the supermarket requires fewer than the standard serial numbers. Furthermore, particular supermarkets carry only certain brands and types of products. Additionally, there is generally variation of store inventory between different locations of a supermarket chain, where this variation can be due to a variety of factors, e.g., size of the store, perceived general ethnicity, or economic class of the customers of the store. For example, supermarkets that have a significant base of Latin customers tend to carry products geared towards those customers. Additionally, geographic location of stores also influences store inventory. For example, one location of a supermarket chain located in Miami, Fla. carries some different products than another location of the supermarket chain located in Seattle, Wash. Although discussed with respect to a supermarket, the invention is not so limited and can be applied to any environment where goods are sold or services or information are provided.

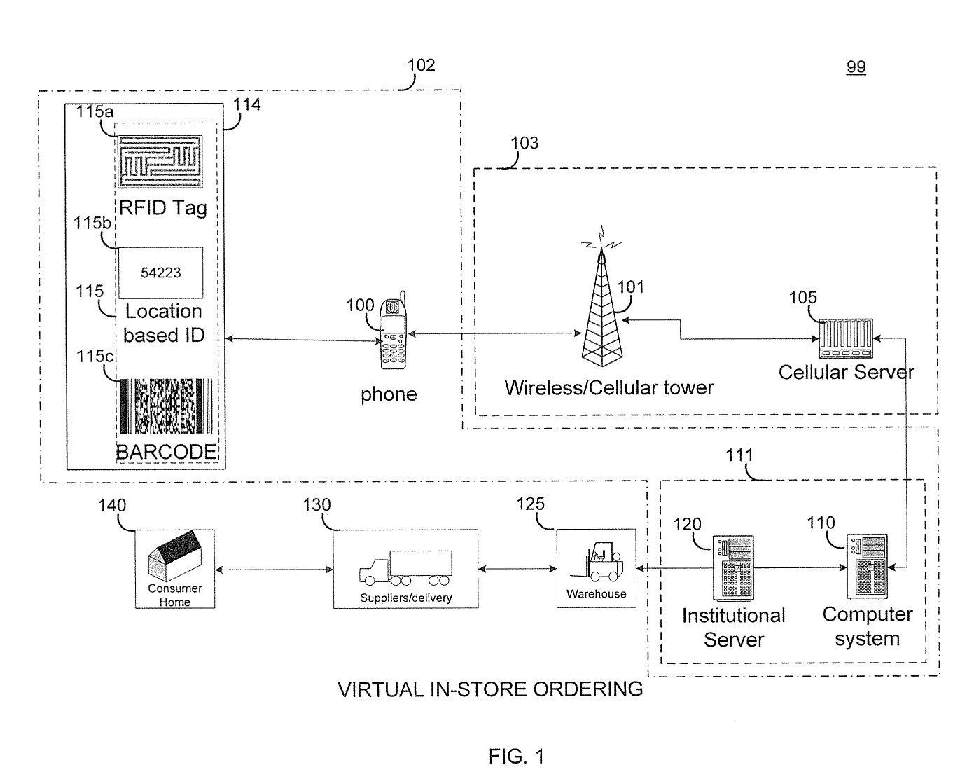

FIG. 1 depicts a system 99 having: a product 114 in a store 102, a mobile communication device 100, a cellular communication system 103, a store computer system 111, a product warehouse 125, a product delivery system 130, and a user's home 140. The product 114 has at least one product identification medium 115a, 115b, or 115c, collectively referred to as identifying information 115, having reduced product identifying information. Product identification medium 115a is an RFID tag that contains electronic data as is commonly known. The reduced product identifying information is stored electronically in the RFID tag and can be read as commonly known with a device being equivalent to an RFID reader. Product identification medium 115b is a printed tag, e.g., paper or adhesive label, having ink or some similar marking mechanism, which physically displays a reduced product identifying information. Product identification medium 115c is a matrix bar code. A matrix bar code applies to 2-D codes that code the data based on the position of black elements within the matrix. Each black element is the same dimension and it is the position of the element that codes the data. The more widely used bar codes are referred to as ID bar codes, or “vertically redundant” bar codes, where information is stored in the bar code in a horizontal fashion, as is commonly known, and the height of the bars are not limiting. To reduce reading and comprehension error, typically information represented by the bar codes are redundantly encoded.

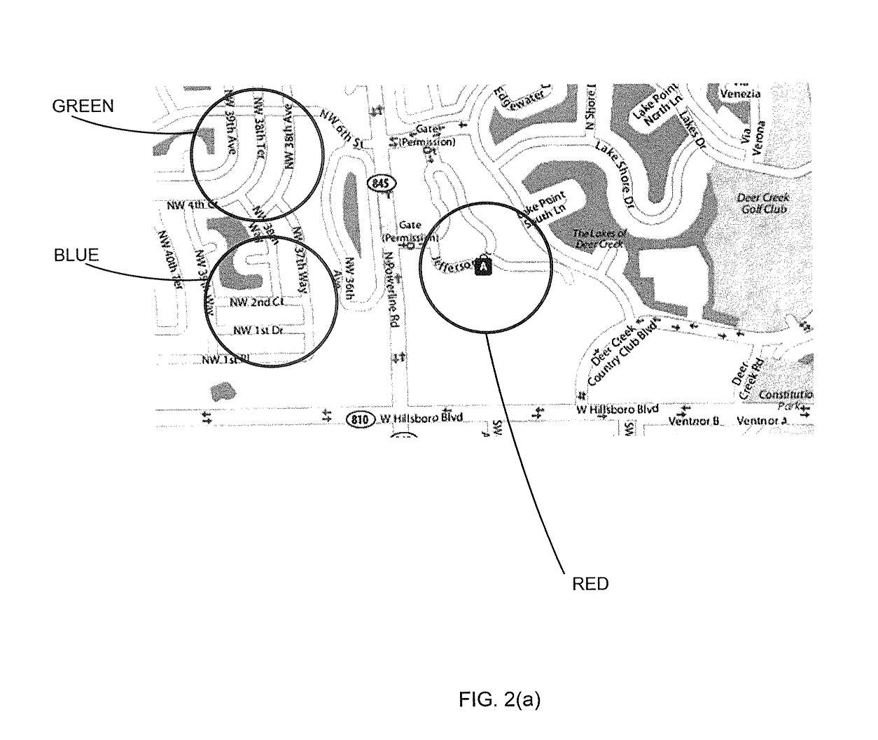

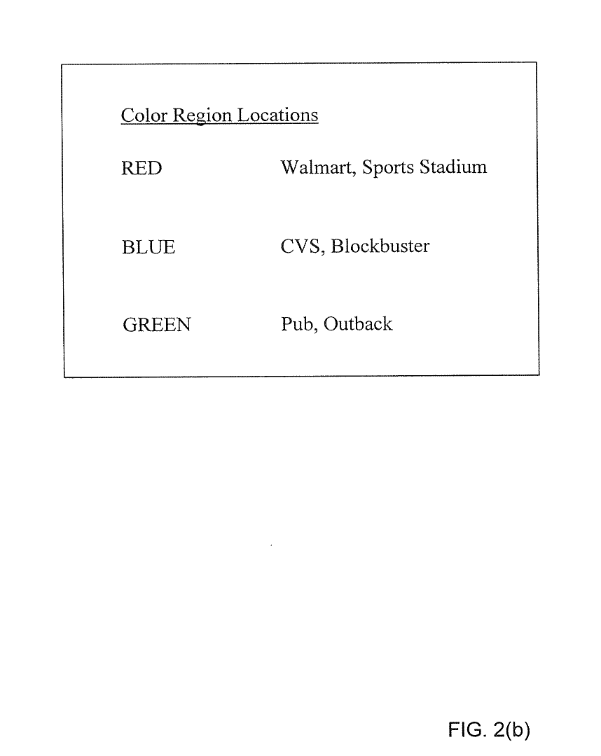

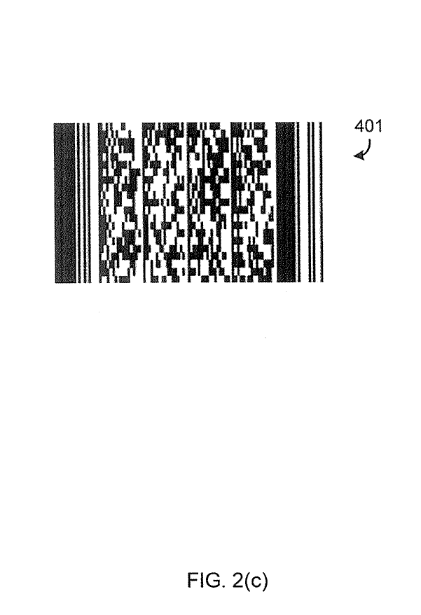

A two-dimensional code, stores information along the height as well as the length of the symbol. In fact, all human alphabets are two-dimensional codes. Since both dimensions contain information, at least some of the vertical redundancy is gone. Other techniques must be used to prevent misreads and to produce an acceptable read rate. Misread prevention is relatively easy. Most two-dimensional codes use check words to insure accurate reading. Acceptable read rate is a different problem, and no research has been done to date to assess first read rates. FIG. 2 (c) depicts a matrix bar code, which is also referred to as a “2D” or “2 Dimensional” bar code. As known to those with skill, the bar code 401 is one of many types of multi-dimensional bar codes and not intended to be limited to the type of bar code 401 depicted in FIG. 2(c). The methods and device combinations provided can be applied to a variety of applications where information is sought in a data transfer.

The system also includes a mobile communication device 100 which is capable of reading and processing RFID tags, if used with products bearing product identification medium 115a, requiring the mobile communication device 100 to be configured to perform Near Field communications (“NFC”) and process that NFC information. The mobile communication device 100 is capable of inputting and processing data from a physical product identification medium 115b if used with products having product identification medium 115b. Thus, the mobile communication device 100 is capable of having a user key-in, input or read conventional bar codes and process that information. The mobile communication device 100 is capable of inputting and processing data from a physical product identification medium 115c if used with products having product identification medium 115c. Thus, the mobile communication device 100 is capable of reading matrix bar codes and processing that information, if desired.

The mobile communication device 100 is wirelessly coupled to the cellular communication system 103 which includes wireless/cellular towers 101 and a cellular computer server 105. The cellular computer server 105 is preferably the cellular network provider associated with the mobile communication device 100.

The store computer system 111 includes a plurality of computers, including a computer system 110 and an institutional server 120.

The product warehouse 125 is either part of the store 102 or associated therewith. The product warehouse receives an order for a product 114 from the store computer system 111 and makes arrangements to ship product 114 to the user home 140 using a supplier/delivery person 130.

In a first embodiment, the user's location and product/service information is provided to a computer system and used to determine the product, service, or information desired by the user; the computer system provides a corresponding application or service to the user's mobile communication device 100.

Thus, FIG. 1 depicts a context-based, virtual in-store ordering system (“VISO”) where a user using mobile communication device 100, e.g., a cellular telephone, PDA, etc., places an order for a product 114 based on the product identifying information 115 on the product 114. An application on a mobile communication device 100, a system in communication with the mobile communication device 100, or a third party system determines the user's context, e.g., the location of the store 102 where the user has the mobile communication device 100.

In an aspect, a mobile communication device 100 inputs product information identifying information either passively or actively, i.e., without or with the interaction of the user. With active identification, a user actively inputs to the mobile communication device 100 product identifying information 115 using the product identification medium 115a, 115b, or 115c, identifying the product 114. This active input is provided in a variety of ways, for example, by providing input on an input mechanism of the mobile communication device 100, e.g., a key pad. The user can passively input information identifying the product or service by scanning an information tag that identifies a product, e.g., a store has an information barcode that can be scanned by an appropriately equipped mobile communication device 100 or a product or service that has an RFID, or similarly enabled near field communication (NFC) system. Although discussed with respect to product information, the invention is not so limited. For example, service or information may also be requested by a user of mobile communication device 100.

The mobile communication device 100 can also determine its context either passively or actively, i.e., without or with the interaction of the user. With active location identification, a user actively inputs information identifying his location. For example, the user inputs a store name, store location, latitude and longitude, or GPS coordinates. This active input is provided in a variety of ways, for example, by providing input on an input device of the mobile communication device 100, e.g., a key pad, or by scanning an information tag that identifies a location, e.g., a store has an information barcode that can be scanned by an appropriately equipped mobile communication device 100 or a product or service that has an RFID, or similarly enabled near field communication system.

The more specific the context, the less specific the product or service identifying information is required to identify the product or service. Correspondingly, the more products within the context, the more product or service identifying information is required to identify the product or service.

The computer system associated with the mobile communication device 100 correlates the context of the mobile communication device 100 with the product or service identifying information to determine the unique product, service, or information requested by the user controlling the mobile communication device 100. The identifying information has a one-to-one correlation between a product, service, or information. For, example, “123” correlates to 3M 2 inch by 2 inch yellow Post-it® pads, in a single pack of 30 pads; “124” is product information regarding the Post-it® pads; and “215” is a request for a store sales representative to meet the user in the section of the store where the Post-it® pads are normally stocked.

A mobile communication device 100 can determine its location passively, i.e., without the interaction of the user. There are a variety of ways in which a mobile communication device 100, or a system in communication with the mobile communication device 100, passively determines its location. One approach is a Global Position System (“GPS”) equipped mobile communication device 100. Current GPS devices are able to determine position within a few hundred feet. Furthermore, recently produced mobile communication devices 100 include an E911 (enhanced 911) system, which provides and transmits a location identification information signal. Typically used by emergency services to identify the location of a caller, the E911 system can locate a user within a few feet. Although designated E911, the E911 service is not exclusively reserved for use in emergencies or by emergency personal. Another approach to passive location is cellular telephone transmission tracking, where cellular communication systems 103 identify the closest cellular tower 101 and generally use the closest cellular tower 101 to send and receive cellular transmissions to the mobile communication device 100.

As the location of the mobile communication device 100 changes, the cellular communication system 103 can switch which cellular tower 101 is used to communicate with the mobile communication device 100, generally biasing towards using the closest cellular tower to the mobile communication device 100. Thus, a cellular communication system 103 is able to determine the position of the mobile communication device 100 within the range of a cellular tower, where that range can vary significantly, from several hundred feet to 10 miles. Although not generally used, cellular communication systems 103 are also able to triangulate location of a mobile communication device 100 by using and comparing signals carried between a mobile communication device 100 and multiple cellular towers 101. A cellular communication system 103 using triangulation currently is able to determine the position of the mobile communication device 100 with the range and accuracy of the triangulation including the multiple cellular towers 101, where that range can vary significantly, from ⅛-1 mile.

The greater the specificity of the location information, the more accurate the determination of the context. With location information provided actively, the location is very specific. With location information provided passively, the location is generally less specific than information provided actively. Although, using passive techniques like the E911 and GPS provides reasonably specific location information.

The mobile communication device 100 provides the product 114 and location information through communication system 103, preferably initially wirelessly through a cellular system that is networked, to the computer system 111 associated with the mobile communication device 100. The computer system 111 is configured to appropriately process the product and location information and communicate with other computer systems as need be. For example, the computer system 111 works in conjunction with a store computer system 110 to determine the correlation between a product identifying information 115 using the product identification medium 115a, or 115b, or 115c and a product 114.

Using the location information, a computer system 105 in communication with the mobile communication device 100 determines the specific context (e.g., store 102) of the mobile communication device 100. The computer system 111 uses the active location information which should provide unique matching to determine the specific context, e.g., Acme Hardware on 5^{th} and Main, Cooper City, Fla. Alternatively, using the passive location, if the location information is specific enough, the computer system 111 determines specific context to the best of its ability, e.g., Cooperstown Delights, 405 Rodeo Drive, Los Angeles, Calif. Using the passive location, if the location information is not specific enough, the computer system 105 determines a range of specific contexts, e.g., the Video Rental Store, Gas Station, the market, and dry cleaners on the 1500 block of Almeida, in Atlanta, Ga.

FIG. 1 also exemplifies using the system 99 to perform virtual in store ordering (“VISO”), i.e., a user in a store placing an order for a product in the store based on product identifying information. A user with a mobile communication device 100 is interested in a product 114 that is located in a store 102 and selects and causes to execute an appropriate program on the mobile communication device 100 to perform in store product ordering. The user approaches the product 114 and acquires the product identifying information. The user passively receives the product identifying information by exchanging information between the mobile communication device 100, which is enabled for near field communications, and the RFID tag 115a on the product 114. Alternatively, the user actively provides the product identifying information by entering the location based identification 115b into the mobile communication device 100. The product identifying information 115b is location based identification information that has reduced identifying information. The product identifying information 115c is location based identification information in matrix bar code, which, in an aspect, can be reduced identifying information.

The product identifying information is provided by the mobile communication device 100 through its associated cellular communication system 103 to a computer system 110 associated with the mobile communication device 100. The mobile communication device 100 communicates with computer system 110 through the nearest cellular tower 101 and the cellular server 105 of its associated cellular communication system 103. The computer system 110 acquires the location of the mobile communication device 100 either from the mobile communication device 100, using GPS, E911, or some other service, or from the cellular communication system 103. Using the location of the mobile communication device 100, the computer system 110 determines the context of the mobile communication device 100. Using the determined context the computer system 110 determines the product 114 requested by the user. The computer system 110 communicates with the store's institutional server 120 and orders the product for the user. The institutional server 120 communicates with its warehouse 125 and requests that the product 114 be delivered by delivery service 130 to a location specified by the user, e.g., the user's home 140.

A user places a mobile communication device 100 near a product identifying information 115, e.g., a 2d barcode, of a product and the mobile communication device 100 reads and interprets information from the barcode and the mobile communication device 100 performs an action in an appropriate manner depending on the kind of information. In a preferred embodiment, the mobile communication device 100 uses information associated with the product received from the identifying information 115 tag: to provide this information to the user, to request information about the product from a remote location, e.g., a web site, to request additional information about the product, and to order the product for purchase. For example, when a user places a mobile communication device 100 having smart code capabilities near the identifying information 115 of a product, the mobile communication device 100 receives and interprets information from the identifying information 115 associated the product. The information also contains instructions on how to order the product from a ‘default’ retailer, which, in an aspect, is the retailer where the user and product are located. The instructions are processed by the mobile communications device 100 automatically or manually, requiring some input from the user of the mobile communications device 100. Thus, a mobile communication device 100 will step a user through an ordering process for the product. A program to step the user through the ordering process resides on the mobile communication device 100.

Alternatively, the program resides on another server or computer system and user's mobile communication device 100 provides input to and receives from that server and, in turn, prompts the user for input and provides output to the user, e.g., a thin-client system. For example, the mobile communication device 100 using its input/output capabilities: confirms that the user is interested in purchasing the product, how many of the products the user wants, as well as payment and shipping information. In an aspect, the instructions from the identifying information 115 of a product 114, also includes information regarding different retailers that carry the product, which provides the user the opportunity to select a particular retailer to purchase the product from. The user's selection of a retailer can be driven by a current user preference, for example, price, location, availability, reputation, but the user's selection of a retailer is not so limited. Using information about the desired or default retailer, the mobile communication device 100 communicates with a server associated with the information provided by the product and causes an order to be placed with the server for the product. The server performs back-end processing and processes the order and payment information. And upon confirmation of payment, the server processes the shipping of the product to the user.

In an aspect, the mobile communication device 100 uses the information regarding the product acquired from the identifying information 115 combined with user's information to process the purchase order. The user's information, such as bank or payment information, user's home, billing, and delivery addresses, is previously stored in a storage area of the mobile communication device 100 or contemporaneously entered with product ordering using the identifying information 115 information by the user into the mobile communication device 100. In another aspect, the user's information is stored in a server that processes, or is associated with the server processing, the order in lieu of, or in addition to, user's information stored in the mobile communications device 100. Preferably, the mobile communication device 100 uses its data connection to the Internet to communicate to a server, which is used to transfer the user's information to the server processing the order. The server than connects to the retailer's website and processes the order.

Upon completion of the successful processing of the order, the retailer's site or the middle server then sends an electronic confirmation of the purchase via direct connect message, SMS, or other means, to the user's mobile communication device 100 or other location as designated by the user. This aspect of the invention allows consumers an increased buyer awareness, including, but not limited to, learning of product alternatives or substitutes, continuity products.

Thus, using the location based product identifying information and the context of the mobile communication device 100, a product 114 is identified and ordered for the user.

Although the example use of VISO discussed above is directed to a user purchasing a product in a store, the invention is not so limited. For example, the user can use product identifying information to request the delivery to the user of information about the product. The delivery can be done in any of a variety of methods, including, but not limited to: being sent electronically to the mobile communication device 100, being sent electronically to a user's email account, or being sent information in hard copy to an address designated by the user. In an further example, the user can use product identifying information to request the service to the user from a store employee about the product.

Although not discussed above, in most instances the user will have to pay for the product, service, or information. Thus, the user will have to effectuate payment for the product, service, or information either using the mobile communication device 100, pay for the product at a check-out register, or some other process. Without which, a store is not likely to deliver the product, service, or information.

In the context described above, the user selects the type of request sought: product, service, or information. Thus, the user selects and causes the mobile communication device 100 to run an appropriate application that effectuated ordering a product or a service or information, respectively. Thus, the user's expected response from the mobile communication device 100 and the computer system associated with the mobile communication device 100 was product or service or information ordering. However, the invention is not so limited.

In another aspect, the product or service identifying information is used by the mobile communication device 100 and its associated computer system 105 to determine the appropriate type of user request and therefore the type of response the user is expecting. For example, as depicted in FIGS. 2(a) and 2(b) there are several stores located in the different colored zones, where a zone is a specified area that is uniquely identifiable from another zone. Walmart and a sports stadium are located in the Red Zone, CVS and BlockBuster are located in the Blue Zone, and the Pub and Outback are located in the Green zone. Using the locating capability of the mobile communication device 100 or a computer system 105 associated with the mobile communication device 100 to determine where the mobile communication device 100 is located, and the product or service identifying information, the computer system 105 determines the particular response required.

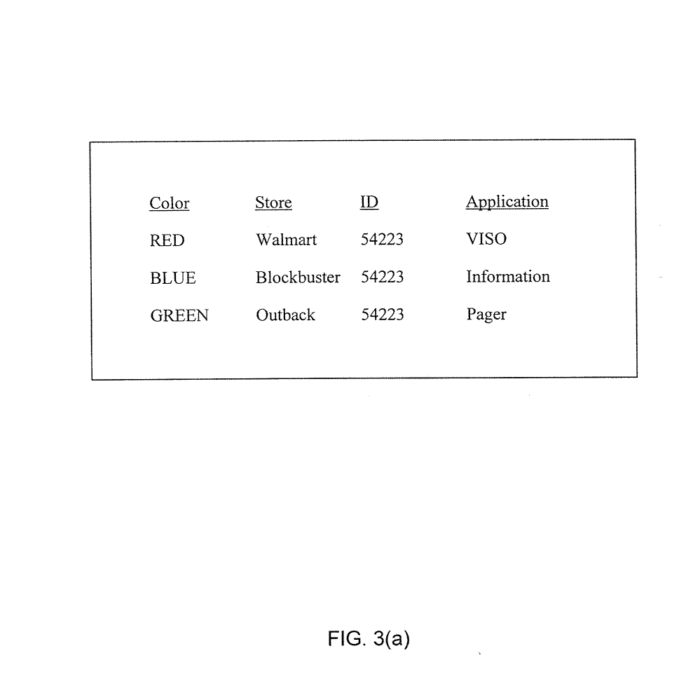

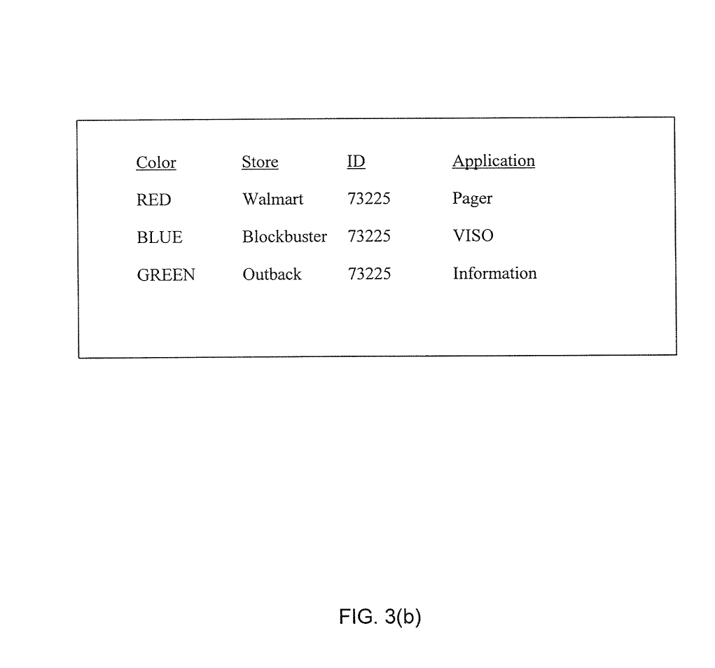

For example, as depicted in FIG. 3(a), if a user with a mobile communication device 100 is in the Red Zone and provides product or service identifying information 54223 to its computer system 105, the computer system 105 determines, using a look-up table, that the mobile communication device 100 is in Walmart and further that the user wants to perform virtual in store ordering of a product. Similarly, if a user with a mobile communication device 100 is the Blue Zone and provides product or service identifying information 54223 to its computer system, the computer system 105 determines that the mobile communication device 100 is in Blockbuster and further that the user wants information provided to the user. Additionally, if a user with a mobile communication device 100 is the Green Zone and provides product or service identifying information 54223 to its computer system, the computer system 105 determines that the mobile communication device 100 is in Outback and that the user wants to perform a paging service (to page a waitress or server for assistance). After the computer system 105 determines the desired response or service requested by the user, the computer system 105 communicates with the user's mobile communication device 100 to request the initiation of an application on the mobile communication device 100 or through the mobile communication device 100 to perform the user's requested service.

In yet another example, as depicted in FIG. 3(b), if a user with a mobile communication device 100 is in the Red Zone and provides product or service identifying information 73225 to its computer system 105, the computer system 105 determines, using a look-up table, that the mobile communication device 100 is in Walmart and further that the user wants to perform a paging service (to page a waitress or server for assistance). Similarly, if a user with a mobile communication device 100 is the Blue Zone and provides product or service identifying information 73225 to its computer system, the computer system 105 determines that the mobile communication device 100 is in Blockbuster and further that the user wants to perform virtual in store ordering of a product. Additionally, if a user with a mobile communication device 100 is the Green Zone and provides product or service identifying information 73225 to its computer system, the computer system 105 determines that the mobile communication device 100 is in Outback and that the user wants information provided to the user. After the computer system 105 determines the desired response or service requested by the user, the computer system 105 communicates with the user's mobile communication device 100 to request the initiation of an application on the mobile communication device 100 or through the mobile communication device 100 to perform the user's requested service.

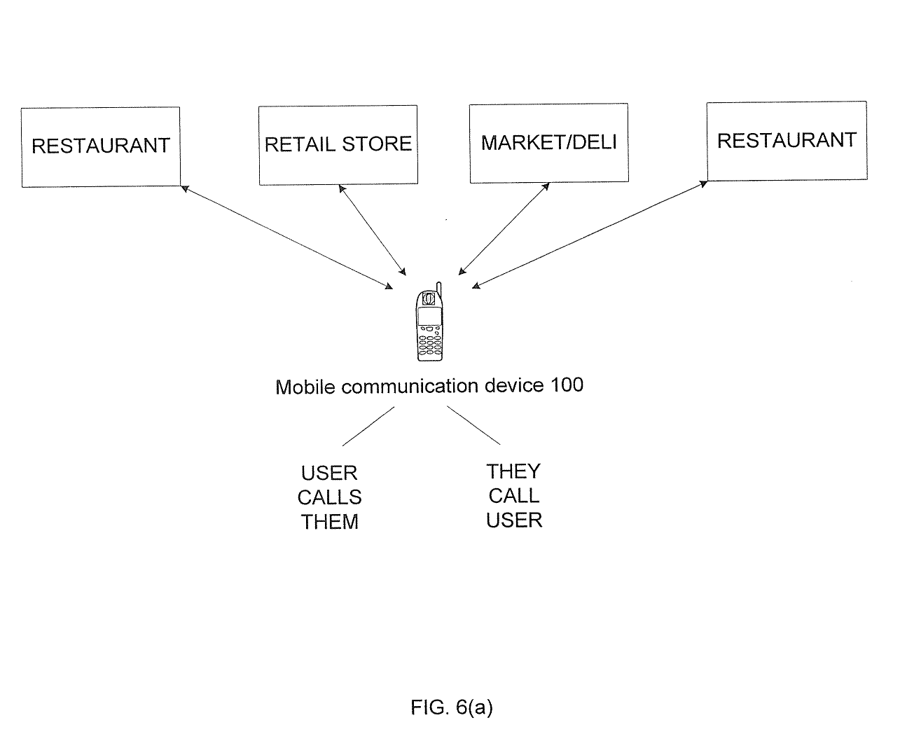

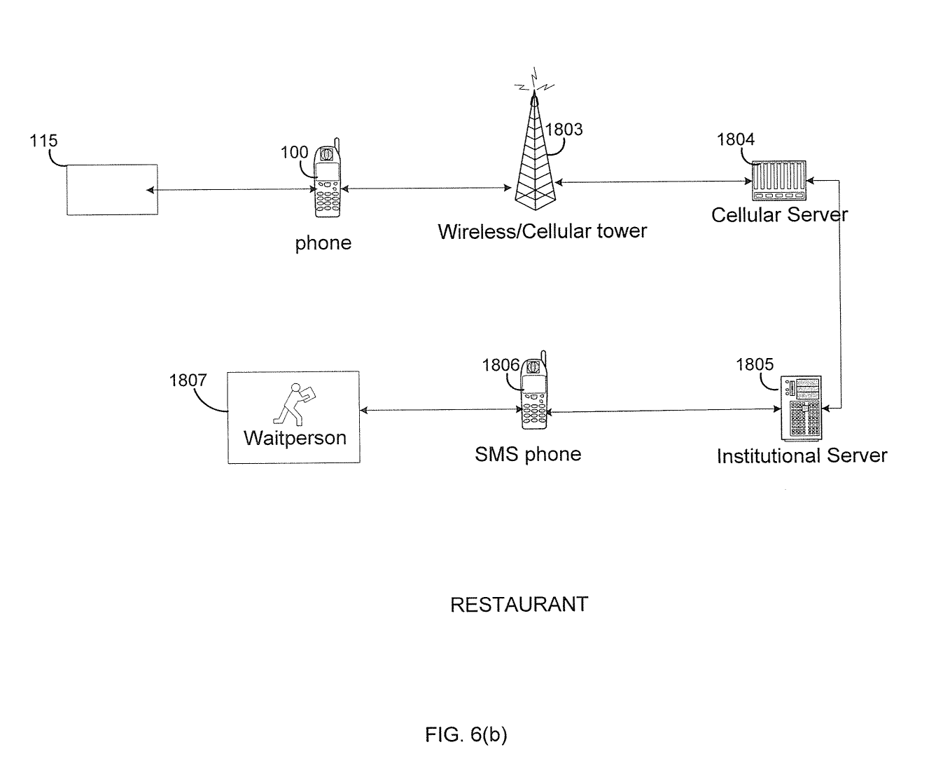

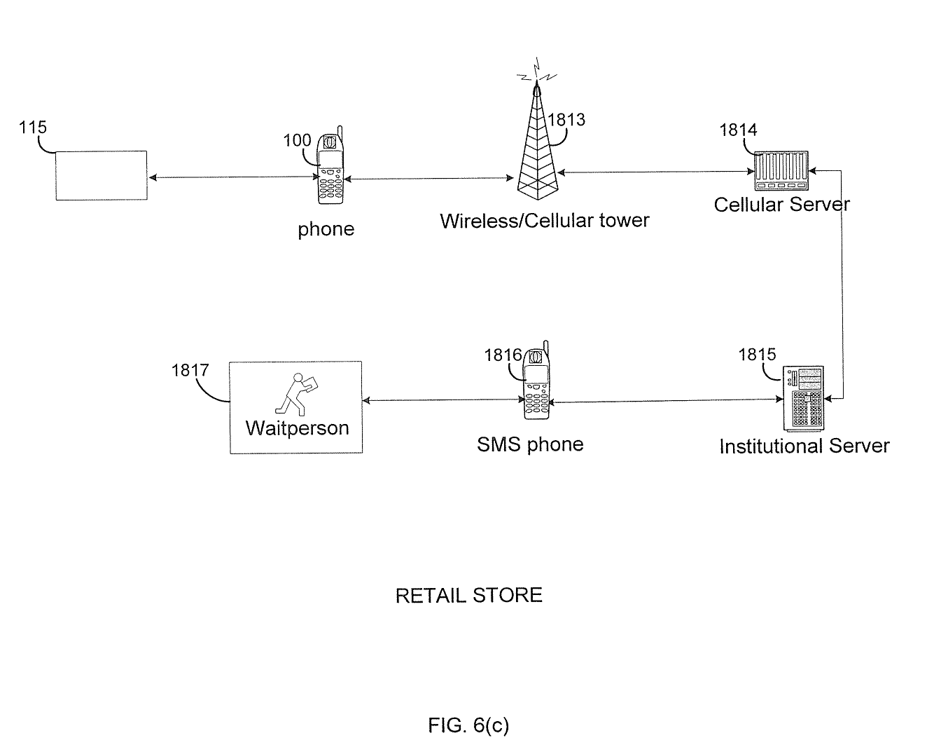

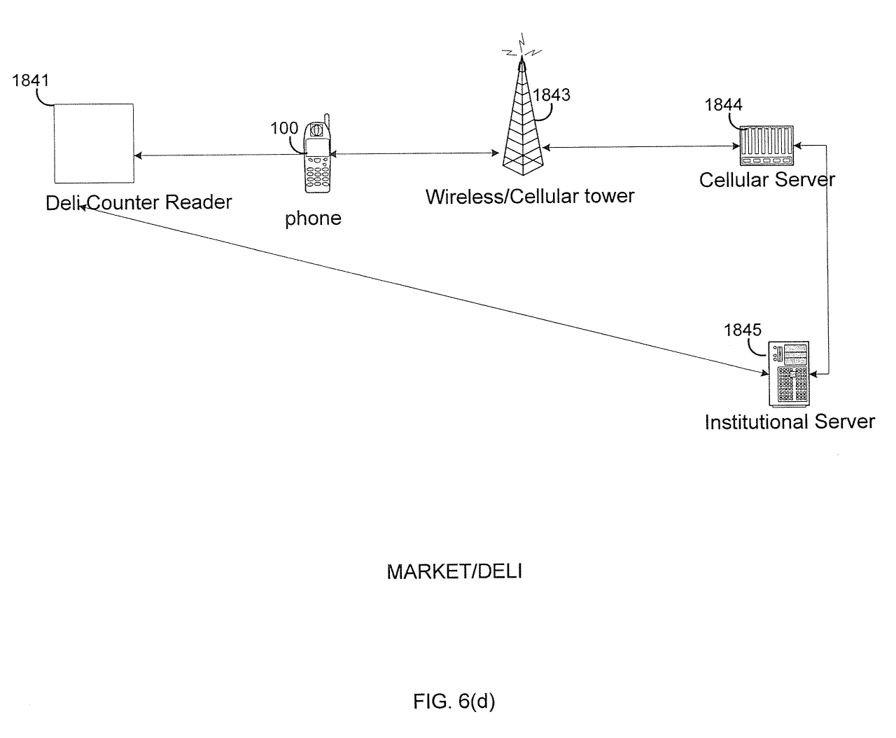

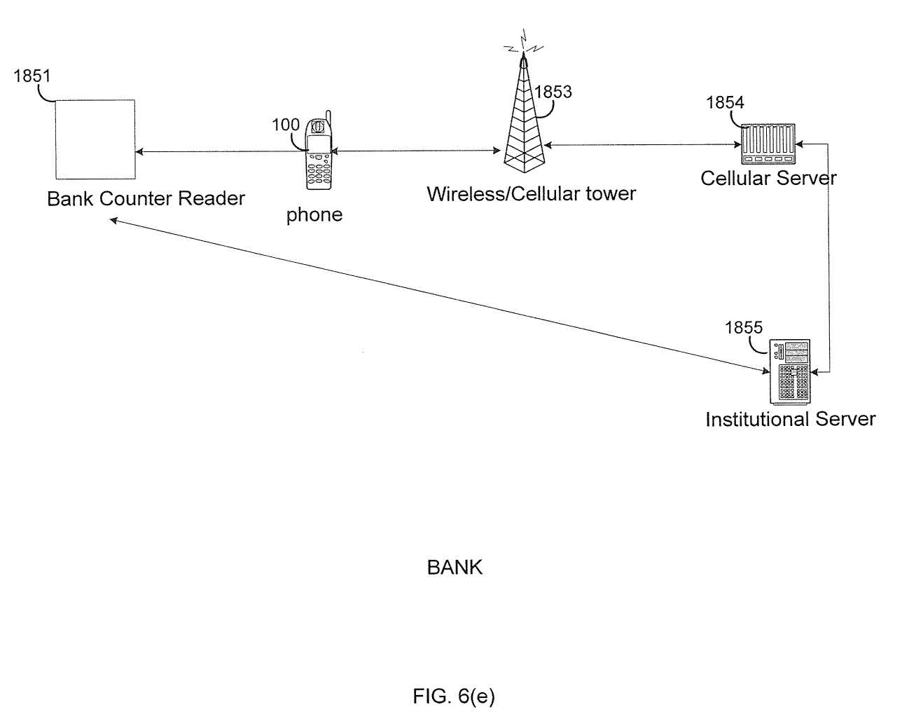

In another aspect of the invention, a mobile communications device is used to page individuals, as seen for example in FIGS. 6(a)-e. In an exemplary use, a mobile communications device 100 reads information, preferably, from a identifying information 115 that provides the information necessary to page a person or thing. For example, the mobile communications device 100 when placed with near identifying information 115, reads the identifying information 115 at a particular location and receives information from the identifying information 115 indicating the contact information, e.g., a phone number, of a person desired to be paged. This information is stored in the mobile communications device 100, and used, when initiated by the user on the mobile communication device 100, to page the person, preferably by an application of a secure transfer program residing and operating on the mobile communication device 100. Additionally, the mobile communication device 100 provides additional information to the person being paged, including, but not limited to, a location or phone number to respond to.

For example, in a store or restaurant, the paging system is used to request assistance from a store or restaurant employee. Identifying information 115 at a specified location is read by a mobile communication device. The mobile communication device 100 executing an appropriate program provides its user an option to page a store associate or waitress. If the user accepts the option, the mobile communication device 100, using the information acquired and interpreted from the identifying information 115, e.g., the business and specific location in that business where the consumer is located and information to establish communications with a server associated with the business, will send the user's location information to the server associated via the wireless or Internet data connection of the mobile communication device. The server, based on the information received from the mobile communication device, will understand the location of the user requesting a page. The server will then provide that information to the business at that location of the user so that the business can, in turn, notify an employee where a user is requesting assistance. In another aspect, the server accesses business records associated with the business where the user is located, and determines what employees are currently working. Having determined what employees are working, the server sends a call out to that specific employee via SMS, MMS, mobile communication device, or other communication means. The employee then is directed to the user at the specified location in the business. In another aspect, the information on the identifying information 115 is used by the mobile communication device 100 to communicate directly with a business employee based on the information from the identifying information 115. The information on the identifying information 115 is contact information for an employee or employees of the store, e.g., a phone number, a cell phone number, an email address, instant messaging address, etc. The mobile communication device 100 uses the contact information to directly communicate, e.g., by calling or emailing, with the business employee.

In an exemplary use in a restaurant, as depicted in FIG. 6(b), identifying information 115 located on a restaurant table is read by a customer's mobile communication device 100. The mobile communication device 100 communicates through its cellular tower system 1803 to its cellular server 1804. The cellular server 1804 communicates with the business server 1805 which determines an appropriate employee, e.g., a waitperson, and then communicates with the communication device 1806 of the waitperson 1807.

In another exemplary use in a store, as depicted in FIG. 6(c), a identifying information 115 is read by a customer's mobile communication device 100. The mobile communication device 100 communicates through its cellular tower system 1813 to its cellular server 1814. The cellular server 1814 communicates with the business server 1815 which determines an appropriate employee, e.g., a salesperson, and then communicates with the communication device 1816 of the salesperson 1817.

In another aspect, the mobile communication system is used to be a recipient of page, for example, based on a queuing or some other ordering system which could be used in such scenarios as a deli or a bank line, as seen for example in FIGS. 6(a)-(e). The consumer can tap (e.g., place their mobile communication device close enough to an NFC reader to permit NFC communications) their mobile communication device to a NFC reader or NFC tag. The NFC reader in the deli scenario receives user information from the user's mobile communication device through a NFC communication. That user information is contact information of the user, e.g., the mobile communication device phone number or email address of the consumer. The reader at the deli, working alone or in conjunction with a computer server, has pre-defined rules that will send a page at an appropriate time when it is the user's time for service. The reader at the deli, either alone or in conjunction with a server sends a page through an Internet connection or telephone system to the user's mobile communication device; the server receives updates as users are processed through the queue and when the service is ready for the next customer. The user can receive that page via SMS, MMS, phone call, or other communications protocol. The queuing system and hierarchy can be maintained either at the reader or the reader can simply communicate the information to a server that has an application which controls and processes the paging and queuing of the service entity, e.g., the deli. In another aspect of the service scenario, e.g., a deli, a consumer continues to shopping and is paged based on a predefined advanced notice, e.g., when there is only two people before him in the queue. This paging system creates an efficiency for commerce and service by wasting less time for the consumer.

In an exemplary use in a deli restaurant, as depicted in FIG. 6(d), an NFC reader 1841 located on a deli service counter reads a customer's mobile communication device 100 having NFC capability and receives contact information of the mobile communication device 100. The NFC reader 1841 communicates the contact information to its associated computer system 1845. The computer system 1845 maintains a queuing system and, when the time is appropriate in the progression of the queue to page the customer, the computer system 1845 communicates with a cellular server 1844 and using the contact information contacts the customer's mobile communication device 100 through its tower 1843 and indicates a signal indicating a page.

In another exemplary use in a bank, as depicted in FIG. 6e, an NFC reader 1851 located on a bank service counter which reads a customer's mobile communication device 100 having NFC capability and receives contact information. The NFC reader 1851 communicates the contact information to its associated computer system 1855. The computer system 1855 maintains a queuing system and, when the time is appropriate in the progression of the queue to page, the customer the computer system 1855 communicates with a cellular server 1854 and using the contact information contacts the customer's mobile communication device 100 through its tower 1853 and indicates a signal indicating a page.

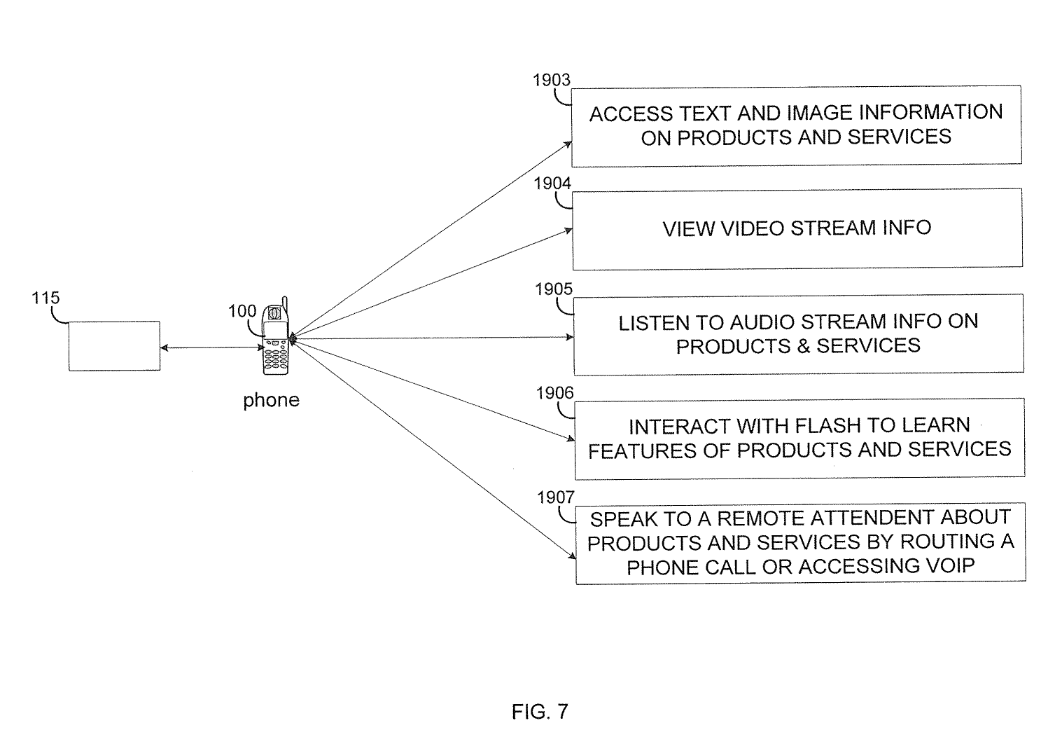

Another aspect of the invention is used to facilitate information on demand as seen for example in FIG. 7. In this aspect, information is provided to the mobile communication device 100 based on the identifying information from bar code 401 (FIG. 2(c)). Although discussed with reference to bar code 401, the invention is not so limited and an identification medium can be used. For example, the users taps their mobile communication device 100 to, and receives information from bar code 401. The mobile communication device 100 processes the information received from the bar code 401 and uses the information to determine and establish communications with its cellular service or the like, and access an Internet website based on the tag information. In an exemplary use, the tag information is a web based URL. The mobile communication device 100 also uses the tag information to determine which application on the mobile communication device is used to perform the access. For example, the tag information indicates that the cellular service is to be used. Any applications on the mobile communication device 100 can be used. Once the application is determined and the application is executed, the mobile communication device 100 application interacts with the website to coordinate the method of communications, e.g., downloading or streaming, as well as other communications issues, e.g., security or restricted websites. In a preferred embodiment, five different types of information 1903, 1904, 1905, 1906, 1907 can be provided to the user through her mobile communication device: Text/Images, Video, Audio, Flash, and phone. These are briefly described as follows:

Text/Images communications permit text and/or images to be viewed by a user on the mobile communication device either by downloading or streaming the text/images to the mobile communication device.

Video communications permit a video to be viewed by a user on the mobile communication device either by downloading or streaming the video to the mobile communication device.

Audio communications permit audio to be played for a user on the mobile communication device either by downloading or streaming the audio to the mobile communication device.

Flash communications permit a flash file to be displayed for a user on the mobile communication device either by downloading or streaming the flash filed to the mobile communication device. A flash file is known to those with skill in the art.

Phone communications permits user to be directly connected to the specific person or service they need or wish to talk to that is defined or connected based on the information received by the mobile communication device from the bar code 401.

Routing of the information to the mobile communication device is performed as conventionally known where an application running on the mobile communication device 100 recognizes the unique scenario and processes that scenario. Information on demand can use the information on the identifying information 115 tag to make the mobile communication device communicate 100 via an internet connection to a server and access one of the five scenarios for information on demand. It can begin a video stream to the mobile communication device 100, it can begin an audio stream to the mobile communication device 100, it can access images and text on the mobile communication device 100, it can access download of an interactive flash file to the mobile communication device 100, or it can route the mobile communication device 100 to initialize a phone call to a specific individual such as a customer service or sales representative specific to that product or service without requiring the consumer to route through menus or voice prompts.

Similarly, in another aspect of the invention, the mobile communication device 100 is a conduit for a web based application. In an exemplary use, web applications are run on the mobile communication device 100 in two ways: first, an application is a thin client, where an application on the mobile communication device 100 seamlessly accesses a web based application that can run on the mobile communication device 100 but the consumer can not tell the difference between the web based application existing on the mobile communication device 100 as an installed and executing program on the mobile communication device 100 or the application “virtually” being on the mobile communication device 100 and actually being executed on a remote server and being displayed on the display of the mobile communication device 100 and using inputs of the mobile communication device 100. In a second scenario, the mobile communication device 100 runs a first application that recognizes, based on a self identification system, the type and kind of second application. The first application accesses the data connection of the mobile communication device 100 and communicates with a web location associated with the second application.

From the web location, the mobile communication device 100 receives either the third application, a subapplication which is related to the second application, or the information that the first application needs to build and install the third application on the mobile communication device 100. Thus, in this scenario, as the second application remains on the remote server and is not installed on the mobile communication device 100, limits to the mobile communication device 100's memory are not an issue. Sub-applications that are used often stay on the phone, and applications that are not used often are deleted and replaced with new applications depending on the use and need of the individual using the mobile communication device 100. Both scenarios solve the issue of limited space on the memory of mobile communication device 100 allowing hundreds and even thousands of applications on the mobile communication device 100 capitalizing on high speed wireless data networks.

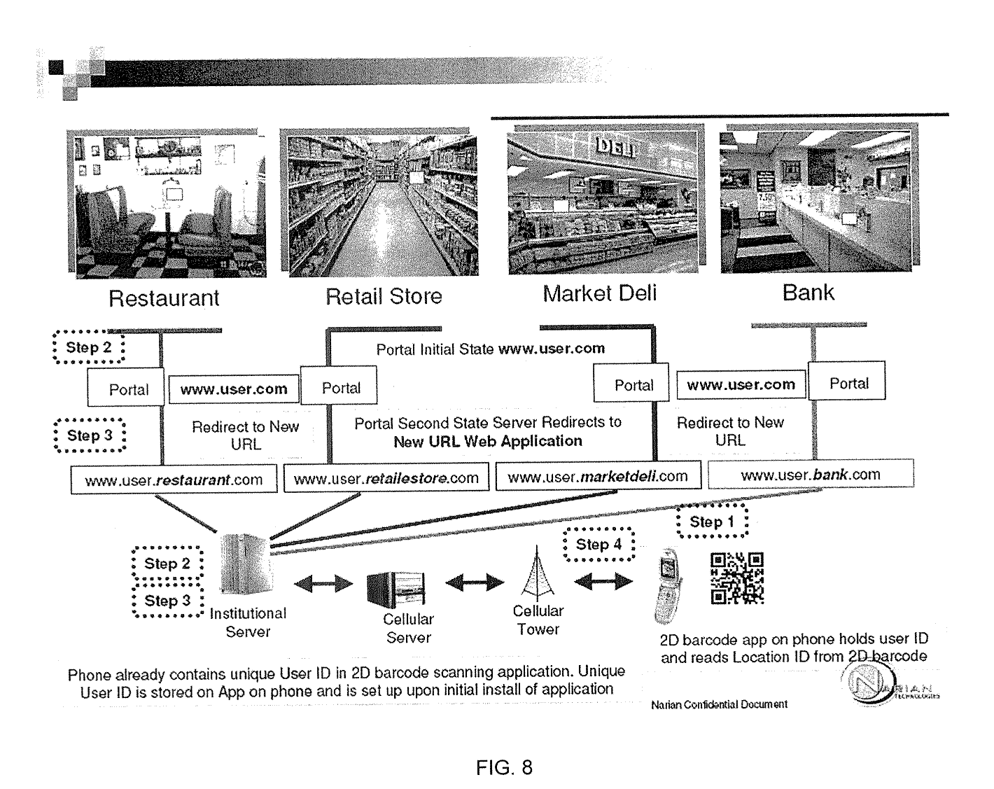

Another exemplary use of information encoded in a barcode 401 or other identification medium, is depicted in FIG. 8. In the system of FIG. 8, a user is directed to a particular Internet location based on information acquired from a identifying information 115. For example, the mobile communication device 100 is directed to a URL associated with the user and the information contained on the identifying information 115. Thus, in a first step, the mobile communication device 100 reads the identifying information 115, e.g., context, location, service, or business information. The mobile communication device 100 includes a user's unique identification information (UID). In a second step, the mobile communication device 100 provides the UID and the information from the identifying information 115 to an institutional server, through the mobile communication device 100's server. In a third step, the institutional server determines, based on the UID and the information from the identifying information 115, a web location associated with both pieces of information. For example, the web is a restaurant, store, market, or bank web location also associated with the user. In a fourth step, the user, interacts with web based application, service, or content as determined by the web location.

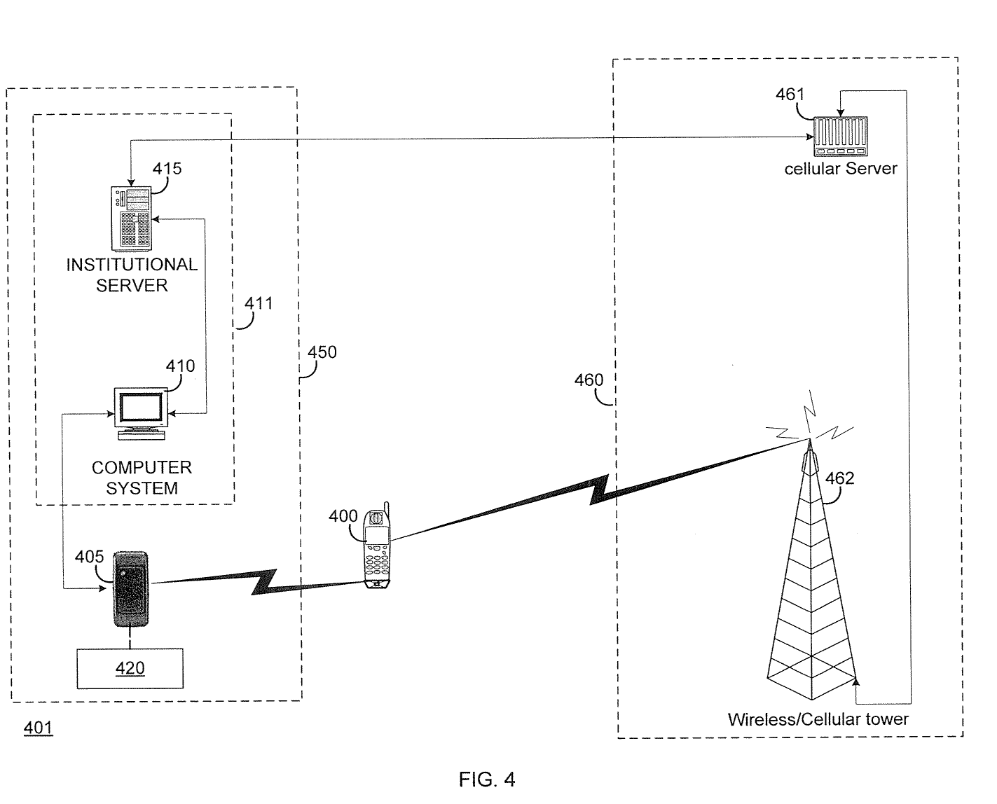

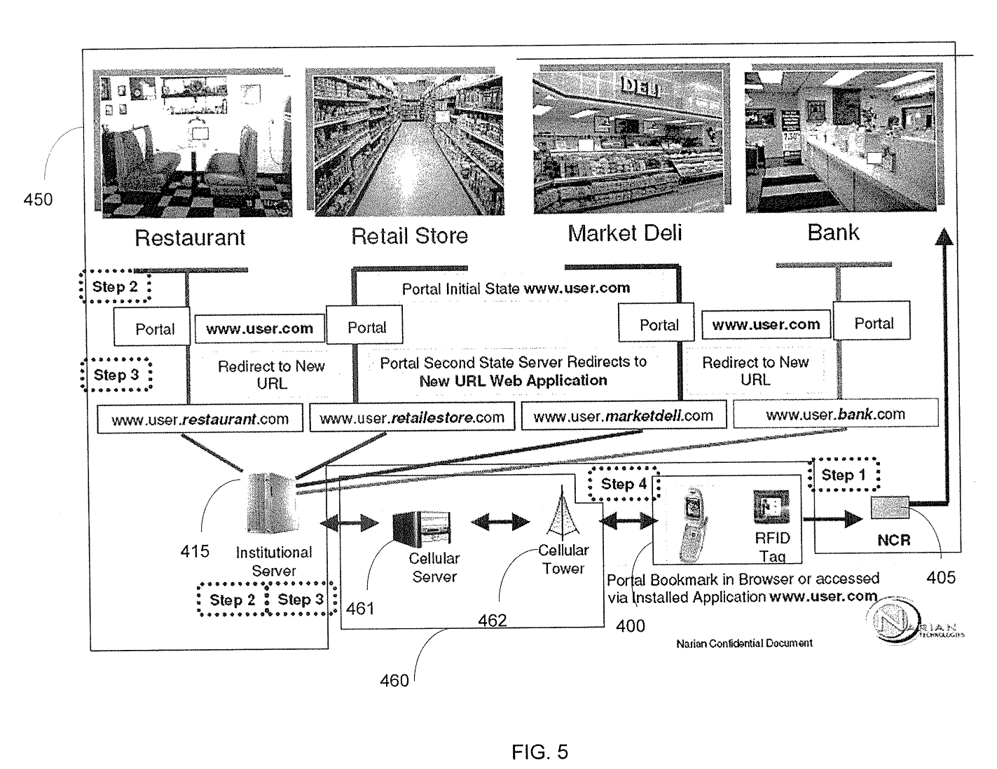

In another aspect, a mobile communication device 400 provides a user with service identifying information and institutional computer system requests, as depicted in as the FLIP system 401 of FIGS. 4 and 5. In the prior embodiment, the user's location and reduced product/service information is provided by the mobile communication device 100 to a computer system 105 associated with the mobile communication device 100, or determined by the computer system 105, and used to determine a product, service, or information desired by the user and the computer system 105 provides the corresponding application or service to the user's mobile communication device 100. In this aspect, an institutional computer system 411 receives information identifying a mobile communication device 400 and product/identifying information provided by an information reader 405 and computer system 410 associated with the information reader, and the institutional server 415 determines the product, service, or information desired by the user and the institutional server provides the corresponding application or service to the user's mobile communication device.

The FLIP system 401 includes a mobile communication device 400, a location 450, e.g., a store, which includes a product or service 420, includes an information reader 405, a store computer system 411, a local computer system 410, and an institutional server 415, and a cellular communication system 460.

In a preferred embodiment, a mobile communication device 400 is near field communication capable, e.g., RFID capable, by either including an RFID tag/circuit or by being configured to emulate an RFID tag/circuit, and includes RFID data, which includes a unique identifier for the RFID tag/circuit that corresponds to the mobile communication device 400, e.g., user identification information (“UII”). The mobile communication device 400 is configured to communicate with and is wirelessly coupled to the cellular communication system 460 which includes wireless/cellular towers 462 and a cellular server 461. The cellular server 461 is preferably the cellular network provider associated with the mobile communication device 400. The UII includes information particular to mobile communication device 400, for example, the cellular telephone number or a server associated with the mobile communication device 400. The mobile communication device 400 is wirelessly connected to a cellular server 461, e.g., its cellular connection, which provides data communications between the mobile communication device 400 and the server 461. In turn, as is commonly known, the server 461 provides the mobile communication device 400 with communication service to the Internet and other phone and cellular servers. As such, the server 461 provides the mobile communication device 400 the ability to run Internet based services, applications, and other content on the mobile communication device 400, e.g., web browsers and the like.

The store computer system 411 includes a plurality of computers, which includes a local computer system 410 and an institutional server 415, e.g., a NFC server. The store 450 includes an information reader 405 and products 420, and a cellular communication system 460. The store computer system 411 is associated with the store 450 and its operation.

The information reader 405 is a near field communication (“NFC”) receiver/reader or RFID reader 405, also referred to as a network connected reader, also has a unique identifier that indicates the scenario that the information reader 405 represents, e.g., a product or service of a store 450. For example, a product/service 420, has an associated information reader 405. The information reader 405 is programmed or designed with product/service identifying information (“PSII”). The PSII is provided to the computer system 410 of the store 450. The PSII identifies which location/context and which product, service, or information that the user of mobile communication device 400 is interacting or dealing with in the physical world. That unique application, service, or content can run on the mobile communication device 400 via the mobile communication device 400 browser or a network connected applications on the mobile communication device 400. The PSII is provided to the computer system 410 of the store 450.

The computer system 410 determines the appropriate scenario by using the PSII and correlating it to the business' products and services. The computer system 410 can also determine that a type or context of the information reader 405, e.g., a vending machine, etc. After determining the scenario that the information reader 405 represents and using that information and the UII, the computer system 410 sends the scenario information and the PSII to the institutional server 415 of the store 450. The institutional server 415 provides the scenario information to mobile communication device 400 through the cellular system 460. The scenario may be a web portal, or other similar application. The mobile communication device 400 runs the scenario either on the mobile communication device 400 or through the mobile communication device. The mobile communication device 400 may also provide information back to the institutional server 415, which may in turn communicate this to web portal in the Internet. Although discussed above as the computer system 410 and the server 415 being different systems, as noted above, the computer system 410 and the NFC server 415 can be parts of a overall business computer system.

The information reader 405 communicates with a server 415 via a wired or wireless connection, which in turn, communicates with the Internet or other services via phone or wireless communication systems. The information reader 405 is self powered or can be powered via a power coupling connection. The information reader 405 reads information, e.g., UII, from the mobile communication device 400's RFID tag/circuit. The information reader 405 provides the UII information to the server 415, which in turn can provide it to other destinations or computer systems.

The server 415 receives the PSII and scenario information from the computer system 410. The server 415 receives the UII and determines the mobile communication device 400 from the UII. The server 415, using the UII and the scenario information, initiates an application, content, or service on the mobile communication device 400. The user of the mobile communication device 400 thus has a registered and securely accessed portal where the applications, content, or service is run virtually on the server 415, but interacts with the user's mobile communication device 400. The server 415 can also forward the UII and PSII information to other servers that initiate an application, content, or service on the mobile communication device 400. The user interacts with the applications, content or service through the input/output systems of the mobile communication device 400.

The server 461 and server 415 are servers configured to run web or network based applications. Applications on the mobile communication device 400, whether web or network based, are actually run on at least one of the server 461 and server 415, but are displayed on the display area of the mobile communication device 400. A user on the mobile communication device 400 can interact with the applications through the mobile communication device 400 in a method known commonly as a thin client service. At least one of server 461 and server 415 are designed to recognize and to run particular applications based on the information received from the information reader 405, e.g., PSII. At least one of the server 461 and server 415 are designed to recognize, based for example, on the UII, the mobile communication device 400 to run the applications on.

The UII defines a unique portal, a virtual bucket in cyberspace associated with the mobile communication device 400. At least one of the mobile communication device server 461 and server 415 fill that bucket with an appropriate application based on the PSII, but that specific bucket is defined by that specific UII. Once that bucket is filled, that specific application is launched on the mobile communication device 400.

An example of portal in cyberspace is a user visiting Yahoo™ or AOL™ on the Internet. When the user enters the portal by, for example, linking to the home page, a user is presented with choices to run different applications such as email or a calendar. In the portal of the FLIP system 401, the portal runs physical world applications on the mobile communication device 400 through a virtual connection from the mobile communication device 400's wireless cellular connection.

To get an application to run on the mobile communication device 400 when dealing with a physical world situation, a user of the mobile communication device 400 either manually provides directions, e.g., a URL, to the mobile communication device 400. Alternatively, the mobile communication device 400 receives directions from a device coupled to the mobile communication device 400 and reads directions from an information source, e.g., a mobile communication device 400 coupled to a RFID reader and reading a barcode or an RFID tag. These approaches can be costly and difficult. In a preferred embodiment of the FLIP system 401, an application or other service is provided on the mobile communication device 400 by a server, e.g., mobile communication device server 461 or server 415.

In an exemplary use of the FLIP system 401, a user with a mobile communication device 400 is shopping in Walmart. The user first identifies an item that he is interested in ordering. The user approaches the item and places his mobile communication device 400 near an information reader 405. The information reader 405 receives the UII from the mobile communication device 400. information reader 405 provides the UII it received and its PSII to its server 415. The server 415 determines based on the PSII that the user is interested in purchasing the item and using the UII determines the mobile communication device 400's portal. The server initiates a program on the mobile communication device 400 that will permit the user of the mobile communication device 400 to purchase the item.

In another exemplary use of the FLIP system 401, a user with a mobile communication device 400 is at a nightclub and is interested in a service or product offered by the nightclub. The user presents his mobile communication device 400 near an information reader 405 on a table where he is seated. The information reader 405 receives the UII from the mobile communication device 400. Information reader 405 provides the UII it received and its PSII to its server 415. The server 415 determines based on the PSII that the user is interested in a service or product offered by the nightclub and using the UII determines the mobile communication device 400's portal. The server 415 initiates a program that is run on the mobile communication device 400 through a web portal that will permit the user of the mobile communication device 400 to select and purchase a service or product offered by the nightclub. A program appears on the mobile communication device 400's display requesting feedback from the user regarding specific choices, for example, whether the user is interested in selecting food or a beverage. Based on the selection, the user is stepped through a series of prompts that guides the user to selecting products offered by the nightclub. For example, if the user desires a Samuel Adams beer, the program will ask the user a series of questions that will help guide his interaction. In another aspect, the program uses voice/text recognition to determine the user's choice. The program confirms the user's selection and concludes the purchase by providing the user payment options. The user chooses credit card payment, for example, and provides his card number through the mobile communication device 400 input to the program. The nightclub's back office processing receives payment from the credit card company and tenders the Samuel Adams to the user.

In another exemplary use of the FLIP system 401, a user with a mobile communication device 400 is at a car dealership and is interested in having some automotive service work performed. The user presents his mobile communication device 400 near an information reader 405 on a table in the service area. The information reader 405 receives the UH from the mobile communication device 400. information reader 405 provides the UII it received and its PSII to its server 415. The server 415 determines based on the PSII that the user is interested in a service or product offered by the car dealership and using the PSII determines the mobile communication device 400's portal. The server 415 initiates a program that is run on the mobile communication device 400 through a web portal that will permit the user of the mobile communication device 400 to select and purchase a service or product offered by the car. A program appears on the mobile communication device 400's display requesting feedback from the user regarding specific choices, for example, what type of service that is requested. Based on the selection the user is stepped through a series of prompts that guides the user to selecting services offered by the car dealership. For example, if the user desires an oil change, the program will ask the user a series of questions that will help guide his decision making and question answering. In another aspect, the program uses voice/text recognition to determine the user's choice. The program confirms the user's selection and performs the user's selected service. The program concludes the purchase of the service by providing the user payment options. Payment for services typically is done after the service is performed. At that time, the user chooses credit card payment, for example, and provides his card number through the mobile communication device 400 input to the program. The car dealership's back office processing receives payment from the credit card company to the user.

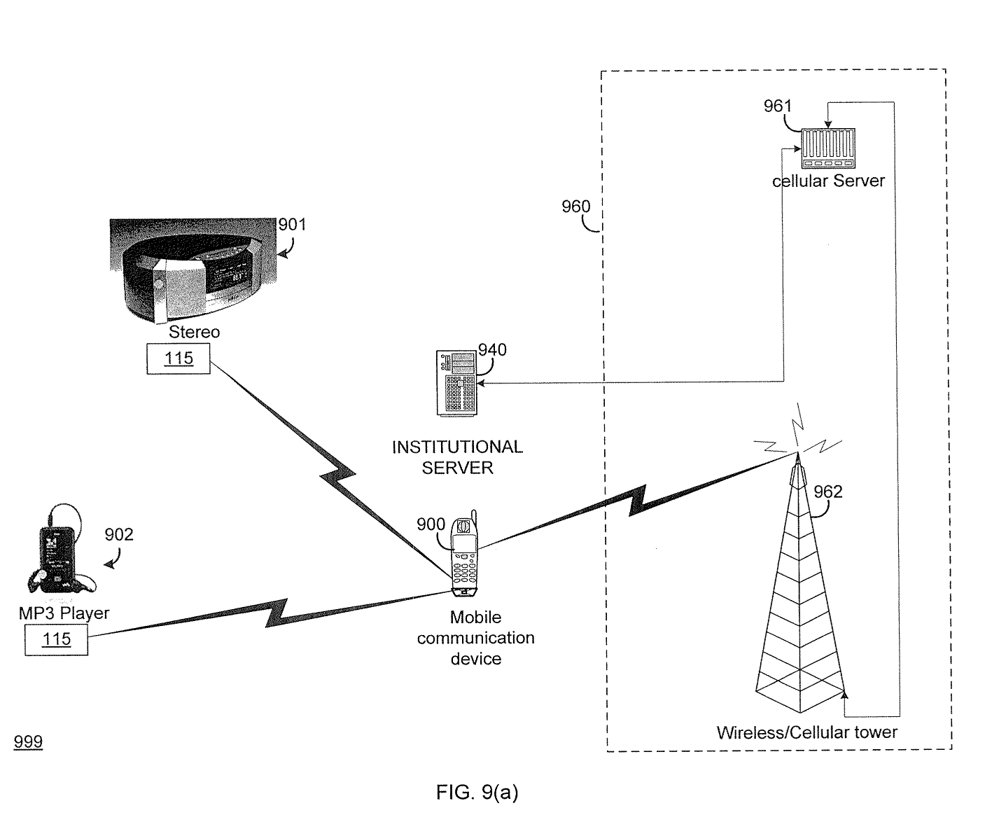

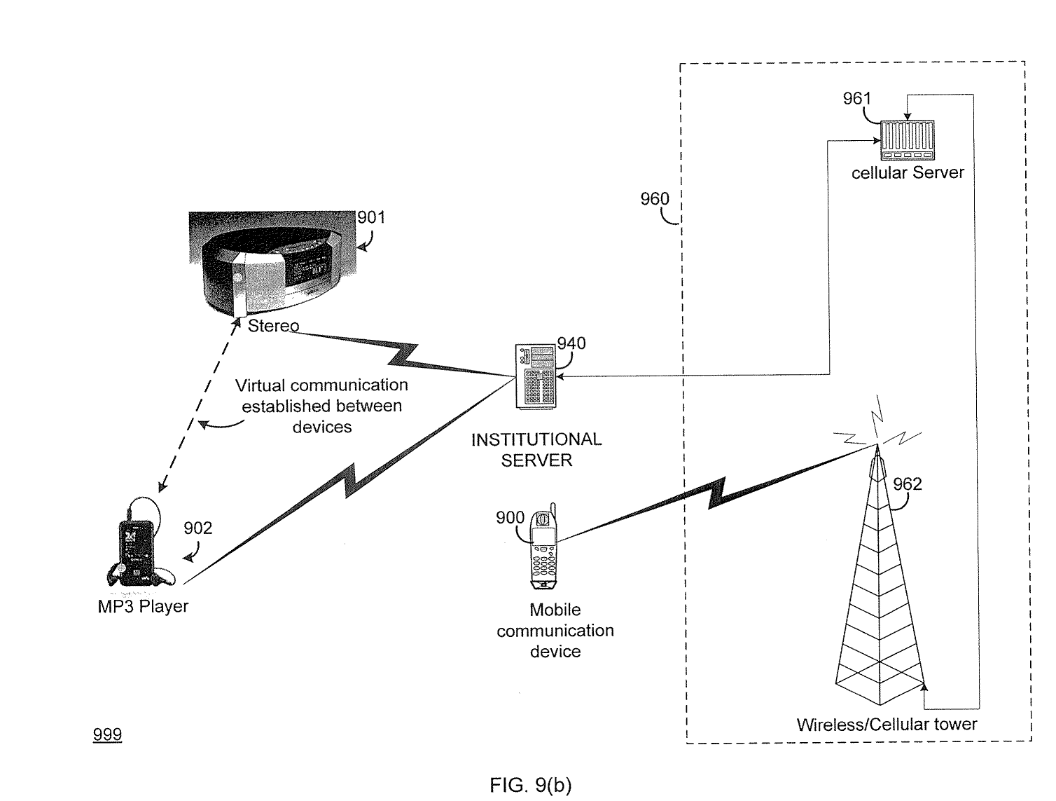

Another exemplary use of the information encoded in the identification mediums such as barcode, RFID tag, NFC tag, or other is depicted in FIGS. 9(a) and 9(b) to bridge devices. User uses mobile communication device 900 to read unique product identifying information from the identification medium 115 of the consumer electronics devices 901, 902, respectively. The communication device 900 is appropriately configured to read and process the identification information 115; e.g., it can read and process RFID, matrix bar code, etc. In this example, but not limited to, the consumer electronic devices are a stereo 901 and an MP3 player 902. Both devices 901, 902 have an Internet connection either via Ethernet, Wifi, or some other means and the devices are uniquely addressable using their respective product identifying information, or information associated therewith, through the Internet. The devices 901, 902 are not initially configured to directly communicate with each other. The mobile communication device 900 reads identifying information 115 from the unique identification medium of both devices 901, 902. The mobile communication device 900 connects wirelessly to a data connection and to a server 940. The mobile communication device 900 provides the server 940 with information regarding consumer electronic devices 901, 902 including identifying information from their respective unique identification medium. The mobile communication device 900 indicates to the server 940 that the consumer electronic devices 901, 902 are to communicate with each other. The server 940 connects, via the Internet, to both devices 901, 902 based on the information provided by the mobile communication device 900 to the server 940 through their respective Internet connections. Then, the server 940 establishes communications between both devices 901, 902. When the server 940 receives a communication from one of the devices 901, 902 the server causes the communication to be provided to the other of the devices 901, 902. Preferably, the server 940 uses information contained in the communication which indicates that the communication is intended to provided to an other electronic device; that information could be, for example, the product identifying information of the other device, but is not so limited. Thus, the devices 901, 902 communicate with each other through the Internet.

While the invention has been described and illustrated with reference to specific exemplary embodiments, it should be understood that many modifications and substitutions could be made without departing from the spirit and scope of the invention, even though a particular embodiment is not specifically described. For example, the different processing segments described above are not limited to those segments or that order of segments, segments may be omitted and still maintain the spirit and scope of the invention. Although generally the description above refers to a processing chip, it should not be so limited and can include many other implementations and instrumentalities. The chip could be, for example, a microprocessor, an integrated circuit, transceiver, or module. Although described with reference to 2D matrix barcode, other types of encoded information could be used where the information is captured in digital form by an imaging system of a mobile communication device. Although described as a mobile communication device and the invention is not so limited and can include various mobile user interfaces including cellular telephones, mobile communicators, personal digital assistants, portable processing devices, keyboard, keypads, and biometric devices. Although several of the examples are described using reduced product identifying information, the invention is not so limited and product identifying information need not be reduced.

Additionally, although several different embodiments and aspects of the invention are described above, the methods of use are applicable to every variation of the invention although each embodiment may require a modification of the methods of necessary to be adapted to each invention. Further adaptation of the methods of use may be required for the use of the invention in different contexts. Furthermore, in the processes/methods of use descriptions above, separate processes/segments may be combined into a single process/segments therefore reducing the number distinct processes/segments and visa versa; process that are represented as a single segment, may be broken down into a plurality of segments.

Although the invention is described above with respect to certain embodiments, the invention is not so limited. For example, although the invention is described with respect to Near Field and cellular communications, the invention can be implemented using any wireless communication systems, including but not limited to near field communications. Additionally, although described with an server and/or a mobile communication device server performing a task, it is generally understood that various combinations of servers can be used and perform the equivalent tasks. For example, a third party server can perform the task at the request of the server and/or a mobile communication device server. Additionally, the invention is not limited to a cellular telephone; any suitable communication system can be used.

Moreover, the examples described above, can be run on mobile communication devices having the appropriate hardware to read and process the appropriate identifying information and appropriate software installed and executing on the mobile communication device and the associated computer server and institutional/store computer system. For the VISO example, e.g. relating to FIG. 1, the mobile communication device can use VISO software from Narian Technologies. For the FLIP example, e.g., relating to FIGS. 6(a)-(e), the mobile communication device can use FLIP software from Narian Technologies.

An advantage of the present invention is that minimal software, in addition to the standard software existing on the devices, has to be installed and operational on the mobile communication device, its associated computer system in the cellular network, and the institutional/store computer systems in order to effectuate the respective examples above. Furthermore, the examples, require little, if any, additional hardware to implement the respective examples.

What is claimed as new and desired to be protected by Letters Patent of the United States is:

1. A context sensitive computer system programmed to determine a product/service/information requested, comprising:
a computer system programmed to input a location information regarding a location of a mobile communication device, programmed to receive a product/service/information identifying information, and being programmed to determine a product/service/information requested by a user based on the location information and said product/service/information identifying information.

2. The context sensitive computer system of claim 1, wherein said computer system is configured to determine a type of user request based on selection information provided by the user, wherein said type of user request is one of a product, service, and information.

3. The context sensitive computer system of claim 1, wherein said computer system is configured to determine a type of user request based on said product/service/information identifying information.

4. The context sensitive computer system of claim 1, wherein said product/service/information identifying information is based on RFID information.

5. The context sensitive computer system of claim 1, wherein said product/service/information identifying information is based on a location based identification number.

6. The context sensitive computer system of claim 1, wherein said computer system is programmed to receive said location information from said mobile communication device.

7. The context sensitive computer system of claim 1, wherein said computer system is programmed to determine said location information of said mobile communication device.

8. A consumer request delivery system, comprising:
an information reader having first identifying information; and
a business computer system coupled to said information reader, said business computer system configured to receive second identifying information associated with a mobile communication device, said computer system configured to determine one of a product, service, and information based on said first identifying information, and configured to cause appropriate information to be provided to said mobile communication device associated with said second identifying information.

9. The consumer request delivery system of claim 8, wherein said first identifying information includes location information associated with said information reader.

10. The consumer request delivery system of claim 8, wherein said first identifying information includes product information associated with said information reader.

11. The consumer request delivery system of claim 8, wherein said first identifying information includes information associated with said information reader.

12. The consumer request delivery system of claim 8, wherein said business computer system is configured to cause an application to run on said mobile communication device associated with said second identifying information.

13. The consumer request delivery system of claim 8, wherein said business computer system is configured to cause an application to run as a thin client on said mobile communication device associated with said second identifying information.

14. A method of providing a user of a mobile communication device with context-based wireless information, comprising:
providing first identifying information associated with an information reader to a computer system;
receiving by the information reader second identifying information associated with said mobile communication device;
providing said second identifying information associated with said mobile communication device to the computer system; and
determining, by the computer system, the type of request sought by the user based on said first identifying information.

15. The method of claim 14, further comprising:
causing an application associated with said type of request to be provided to said mobile communication device, using said second identifying information.

16. The method of claim 14, further comprising:
causing a product to be ordered, wherein said product is associated with said first identifying information.

17. The method of claim 14, further comprising:
causing a service to be provided to a user associated with said mobile communication device, wherein said service is associated with said first identifying information.

18. The method of claim 14, further comprising:
causing a page to be provided to a user associated with said mobile communication device, wherein said information is associated with said first identifying information.

19. The method of claim 14, further comprising:
causing information to be provided to said mobile communication device using said second identifying information, wherein said information is associated with said first identifying information.

20. A method of electronically bridging a plurality of electronic devices, comprising:
receiving a first product identifying information associated with a first electronic device;
receiving a second product identifying information associated with a second electronic device;
receiving a first communication from said first electronic device; and
causing said first communication to communicate with said second electronic device, wherein said first electronic device and second electronic device are not configured to directly communicate.
